(19) United States
(12) Patent Application Publication
(10) Pub. No.: US 2008/0248198 A1
(43) Pub. Date: Oct. 9, 2008

(54) Method for Producing Foam Plates

(75) Inventors: Markus Allmendinger, Edenkoben (DE); Klaus Hahn, Kirchheim (DE); Bernhard Schmied, Frankenthal (DE); Michael Riethues, Ludwigshafen (DE); Edith Antonatus, Mutterstadt (DE)

Correspondence Address: CONNOLLY BOVE LODGE & HUTZ LLP, 1875 EYE STREET, N.W., SUITE 1100, WASHINGTON, DC, 20036, US

(73) Assignee: Basf SE, Ludwigshafen (DE)

(21) Appl. No.: 12/064,407

(22) PCT Filed: Aug. 9, 2006
(86) PCT No.: PCT/EP06/65178

§ 371 Date: Feb. 21, 2008

(30) Foreign Application Priority Data
Aug. 23, 2005 (DE) 10 2005 039 976.2
Apr. 5, 2006 (EP) 06112268.5

(51) Int. Cl. B05D 7/24

(52) U.S. Cl. 427/222

(57) ABSTRACT

The invention relates to a process for producing foam moldings from prefoamed foam particles which have a polymer coating in a mold under pressure, wherein the polymer coating comprises an amphiphilic or hydrophobic organic compound, and also foam moldings produced therefrom and their use.

The invention relates to a process for producing foam moldings from prefoamed foam particles which have a polymer coating and also to foam moldings produced therefrom and to their use.

Expanded foams are usually obtained by sintering foam particles, for example prefoamed expandable polystyrene particles (EPS) or expanded polypropylene particles (EPP), in closed molds by means of steam. For the foam particles to be able to undergo after-expansion and fuse together well to form the foam molding, they generally have to comprise small residual amounts of blowing agent. The foam particles must therefore not be stored for too long after prefoaming. In addition, due to the lack of after-expandability of comminuted recycled foam materials from expanded foams which are no longer usable, only small amounts of these can be mixed in for producing new foam moldings.

Expanded PS foam composites which lead to more fire-resistant products in the coating of EPS beads with water glass or similar inorganic materials are known. However, a disadvantage here is that the water uptake of such products is increased, which in time leads to a possible deterioration in the insulation capability in the case of use as insulating material.

WO 00/050500 describes flame-resistant foams produced from prefoamed polystyrene particles which are mixed with an aqueous sodium silicate solution and a latex of a high molecular weight vinyl acetate copolymer, poured into a mold and dried in air while shaking. This gives only a loose bed of polystyrene particles which are adhesively bonded together at only a few points and therefore have only unsatisfactory mechanical strengths.

WO 2005/105404 describes an energy-saving process for producing foam moldings, in which the prefoamed foam particles are coated with a resin solution which has a softening temperature lower than that of the expandable polymer. The coated foam particles are subsequently fused together in a mold under external pressure or by after-expansion of the foam particles in a customary fashion using hot steam. Here, water-soluble constituents of the coating can be washed out. Owing to the relatively high temperatures at the entry points and the cooling of the steam when it condenses, the fusion of the foam particles and the density can fluctuate considerably over the total foam body. In addition, condensing steam can be enclosed in the interstices between the foam particles.

Hydrophobicized expandable polystyrene particles for perimeter insulation are known, for example, from WO 97/4334 and EP-A 913-423. The hydrophobicizing agents are in this case adsorbed on silica gel and applied in this form to the EPS particles immediately after work-up and drying.

It was therefore an object of the invention to remedy the disadvantages mentioned and to discover a simple and energy-saving process for producing foam moldings having reduced water uptake capability and good mechanical properties, and sufficient flame retardancy.

We have accordingly found a process for producing foam moldings from prefoamed foam particles which have a polymer coating in a mold under pressure, wherein the polymer coating comprises an amphiphilic or hydrophobic organic compound.

As foam particles, it is possible to use expanded polyolefins such as expanded polyethylene (EPE) or expanded polypropylene (EPP) or prefoamed particles of expandable styrene polymers, in particular expandable polystyrene (EPS). The foam particles generally have a mean particle diameter in the range from 2 to 10 mm. The bulk density of the foam particles is generally from 5 to 50 kg/m³, preferably from 5 to 40 kg/m³ and in particular from 8 to 16 kg/m³, determined in accordance with DIN EN ISO 60.

The foam particles based on styrene polymers can be obtained by prefoaming of EPS to the desired density by means of hot air or steam in a prefoamer. Final bulk densities below 10 g/l can be obtained here by single or multiple prefoaming in a pressure prefoamer or continuous prefoamer.

According to the invention, the polymer coating comprises an amphiphilic or hydrophobic organic compound as hydrophobicizing agent. Hydrophobic organic compounds which may be mentioned are, in particular, C₁₀-C₃₀ paraffin waxes, reaction products of N-methylolamine and a fatty acid derivative, reaction products of a C₉-C₁₁ oxo alcohol with ethylene oxide, propylene oxide or butylene oxide or polyfluoroalkyl (meth)acrylates or mixtures thereof, which can preferably be used in the form of aqueous emulsions.

Preferred hydrophobicizing agents are paraffin waxes having from 10 to 30 carbon atoms in the carbon chain and preferably having a melting point of from 10 to 70° C., in particular from 25 to 60° C. Such paraffin waxes are comprised, for example, in the commercial BASF products RAMASIT KGT, PERSISTOL E and PERSISTOL HP and also in AVERSIN HY-N from Henkel and CEROL ZN from Sandoz.

Another class of suitable hydrophobicizing agents comprises resin-like reaction products of N-methylolamine with a fatty acid derivative, e.g. a fatty acid amide, amine or alcohol as described, for example, in U.S. Pat. No. 2,927,090 or GB-A 475 170. Their melting point is generally in the range from 50 to 90° C. Such resins are comprised, for example, in the commercial BASF product PERSISTOL HP and in ARCOPHOB EFM from Hoechst.

Finally, polyfluoroalkyl (meth)acrylates, for example polyperfluoroctyl acrylate, are also suitable. This substance is comprised in the commercial BASF product PERSISTOL O and in OLEOPHOBOL C from Pfersee.

Possible amphiphilic hydrophobicizing agents are antistatics such as Emulgator K30 (mixture of secondary sodium alkanesulfonates) or glyceryl stearates such as glyceryl monostearate GMS or glyceryl tristearate.

A preferred process comprises the steps
a) prefoaming of expandable styrene polymers to form foam particles,
b) coating of the foam particles with a polymer solution or aqueous polymer dispersion,
c) introduction of the coated foam particles into a mold and sintering under pressure in the absence of steam.

Owing to their high thermal insulation capability, particular preference is given to using prefoamed, expandable styrene polymers which comprise athermanous solids such as carbon black, aluminum or graphite, in particular graphite having a mean particle diameter in the range from 1 to 50 μm, in amounts of from 0.1 to 10% by weight, in particular from 2 to 8% by weight, based on EPS, and are known, for example, from EP-B 981 574 and EP-B 981 575.

The polymer foam particles are, in particular, provided with flame retardants. They can for this purpose comprise, for example, from 1 to 6% by weight of an organic bromine compound such as hexabromocyclodecane (HBCD) and, if appropriate, additionally from 0.1 to 0.5% by weight of bicumyl or a peroxide.

The process of the invention can also be carried out using comminuted foam particles from recycled foam moldings. To produce the foam moldings of the invention, it is possible to use 100% of comminuted recycled foam materials or, for example proportions of from 2 to 90% by weight, in particular from 5 to 25% by weight, together with fresh material without significantly impairing the strength and the mechanical properties.

In general, the coating comprises a polymer film which has one or more glass transition temperatures in the range from −60° to +100° C. and in which fillers may, if appropriate, be embedded. The glass transition temperatures of the polymer film are preferably in the range from −30° to +80° C., particularly preferably in the range from −10° to +60° C. The glass transition temperature can be determined by means of differential scanning calorimetry (DSC). The molecular weight of the polymer film, determined by gel permeation chromatography (GPC), is preferably below 400 000 g/mol.

To coat the foam particles, it is possible to use customary methods such as spraying, dipping or wetting of the foam particles with a polymer solution or polymer dispersion or drum coating with solid polymers or polymers absorbed on solids in customary mixers, spraying apparatuses, dipping apparatuses or drum apparatuses.

Polymers suitable for the coating are, for example, polymers based on monomers such as vinylaromatic monomers, such as α-methylstyrene, p-methylstyrene, ethylstyrene, tert-butylstyrene, vinylstyrene, vinyltoluene, 1,2-diphenylethylene, 1,1-diphenylethylene, alkenes such as ethylene or propylene, dienes such as 1,3-butadiene, 1,3-pentadiene, 1,3-hexadiene, 2,3-dimethylbutadiene, isoprene, piperylene or isoprene, α,β-unsaturated carboxylic acids such as acrylic acid and methacrylic acid, their esters, in particular alkyl esters, e.g. C₁₋₁₀-alkyl esters of acrylic acid, in particular the butyl esters, preferably n-butyl acrylate, and the C₁₋₁₀-alkyl esters of methacrylic acid, in particular methyl methacrylate (MMA), or carboxamides, for example acrylamide and methacrylamide.

The polymers can, if appropriate, comprise from 1 to 5% by weight of comonomers such as (meth)acrylonitrile, (meth)acrylamide, ureido(meth)acrylate, 2-hydroxyethyl (meth)acrylate, 3-hydroxypropyl (meth)acrylate, acrylamidopropanesulfonic acid, methylolacrylamide or the sodium salt of vinylsulfonic acid.

The polymers of the coating are preferably made up of one or more of the monomers styrene, butadiene, acrylic acid, methacrylic acid, C₁₋₄-alkyl acrylates, C₁₋₄-alkyl methacrylates, acrylamide, methacrylamide or methylolacrylamide.

Suitable binders for the polymer coating are, in particular, acrylate resins which are preferably applied as aqueous polymer dispersions to the foam particles, if appropriate together with hydraulic binders based on cement, lime cement or gypsum plaster. Suitable polymer dispersions can be obtained, for example, by free-radical emulsion polymerization of ethylenically unsaturated monomers such as styrene, acrylates or methacrylates, as described in WO 00/50480.

Particular preference is given to pure acrylates or styrene-acrylates which are made up of the monomers styrene, n-butyl acrylate, methyl methacrylate (MMA), methacrylic acid, acrylamide or methylolacrylamide.

The polymer dispersion is prepared in a manner known per se, for instance by emulsion, suspension or dispersion polymerization, preferably in an aqueous phase. It is also possible to produce the polymer by solution or bulk polymerization, comminute it if appropriate and subsequently disperse the polymer particles in water in a customary way. In the polymerization, the initiators, emulsifiers or suspension aids, regulators or other auxiliaries customary for the respective polymerization process are concomitantly used, and the polymerization is carried out continuously or batchwise at the temperatures and pressures customary for the respective process in suitable reactors.

The polymer coating can also comprise additives such as inorganic fillers such as pigments or flame retardants. The proportion of additives depends on their type and the desired effect and in the case of inorganic fillers is generally from 10 to 99% by weight, preferably from 20 to 98% by weight, based on the additive-comprising polymer coating.

The coating mixture preferably comprises water-binding substances such as water glass. This leads to better and more rapid film formation from the polymer dispersion and thus more rapid curing of the foam molding.

The polymer coating preferably comprises flame retardants such as expandable graphite, borates, in particular zinc borates, melamine compounds or phosphorus compounds or intumescent compositions which expand, swell or foam under the action of elevated temperatures, generally above 80-100° C., and in the process form an insulating and heat-resistant foam which protects the underlying thermally insulating foam particles against fire and heat. The amount of flame retardants or intumescent compositions is generally from 2 to 99% by weight, preferably from 5 to 98% by weight, based on the polymer coating.

When flame retardants are used in the polymer coating, it is also possible to achieve satisfactory fire protection when using foam particles which do not comprise any flame retardants, in particular do not comprise any halogenated flame retardants, or to make do with smaller amounts of flame retardant, since the flame retardant in the polymer coating is concentrated at the surface of the foam particles and under the action of heat or fire forms a solid framework.

The polymer coating particularly preferably comprises intumescent compositions which comprise chemically bound water or eliminate water at temperatures above 40° C., e.g. alkali metal silicates, metal hydroxides, metal salt hydrates and metal oxide hydrates, as additives.

Foam particles provided with this coating can be processed to give foam moldings which have increased fire resistance and have a burning behavior conforming to class B in accordance with DIN 4102.

Suitable metal hydroxides are, in particular, those of groups 2 (alkaline earth metals) and 13 (boron group) of the Periodic Table. Preference is given to magnesium hydroxide and aluminum hydroxide. The latter is particularly preferred.

Suitable metal salt hydrates are all metal salts into whose crystal structure water of crystallization is incorporated. Analogously, suitable metal oxide hydrates are all metal oxides which comprise water of crystallization incorporated into the crystal structure. The number of molecules of water of crystallization per formula unit can be the maximum possible or be below this, e.g. copper sulfate pentahydrate, trihydrate or monohydrate. In addition to the water of crystallization, the metal salt hydrates and metal oxide hydrates can also comprise water of constitution.

Preferred metal salt hydrates are the hydrates of metal halides (in particular chlorides), sulfates, carbonates, phosphates, nitrates or borates. Suitable metal salt hydrates are, for example, magnesium sulfate decahydrate, sodium sulfate decahydrate, copper sulfate pentahydrate, nickel sulfate heptahydrate, cobalt(II) chloride hexahydrate, chromium(III) chloride hexahydrate, sodium carbonate decahydrate, magnesium chloride hexahydrate and the tin borate hydrates. Magnesium sulfate decahydrate and tin borate hydrates are particularly preferred.

Further possible metal salt hydrates are double salts such as alums, for example those of the general formula: M^{I}M^{III}(SO₄)₂. 12H₂O. M^{I} can be, for example, a potassium, sodium, rubidium, cesium, ammonium, thallium or aluminum ion. M^{III} can be, for example, aluminum, gallium, indium, scandium, titanium, vanadium, chromium, manganese, iron, cobalt, rhodium or iridium.

Suitable metal oxide hydrates are, for example, aluminum oxide hydrate and preferably zinc oxide hydrate or boron trioxide hydrate.

A preferred polymer coating can be obtained by mixing of

from 40 to 80 parts by weight, preferably from 50 to 70 parts by weight, of a water glass solution having a water content of from 40 to 90% by weight, preferably from 50 to 70% by weight,
from 20 to 60 parts by weight, preferably from 30 to 50 parts by weight, of a water glass powder having a water content of from 0 to 30% by weight, preferably from 1 to 25% by weight, and
from 5 to 40 parts by weight, preferably from 10 to 30 parts by weight, of a polymer dispersion having a solids content of from 10 to 60% by weight, preferably from 20 to 50% by weight,
or by mixing of
from 20 to 95 parts by weight, preferably from 40 to 90 parts by weight, of an aluminum hydroxide suspension having an aluminum hydroxide content of from 10 to 90% by weight, preferably from 20 to 70% by weight,
from 5 to 40 parts by weight, preferably from 10 to 30 parts by weight, of a polymer dispersion having a solids content of from 10 to 60% by weight, preferably from 20 to 50% by weight.

In the process of the invention, the pressure can be produced, for example, by decreasing the volume of the mold by means of a movable punch. In general, a pressure in the range from 0.5 to 30 kg/cm² is set here. The mixture of coated foam particles is for this purpose introduced into the open mold. After closing the mold, the foam particles are pressed by means of the punch, with the air between the foam particles escaping and the volume of interstices being reduced. The foam particles are joined by means of the polymer coating to give the foam molding.

The mold is structured in accordance with the desired geometry of the foam body. The degree of fill depends, inter alia, on the desired thickness of the future molding. In the case of foam boards, it is possible to use a simple box-shaped mold. In the case of more complicated geometries, in particular, it may be necessary to compact the bed of particles introduced into the mold and in this way eliminate undesirable voids. Compaction can be achieved by, for example, shaking of the mold, tumbling motions or other suitable measures.

To accelerate setting, hot air can be injected into the mold or the mold can be heated. According to the invention, no steam is introduced into the mold so that no water-soluble constituents of the polymer coating of the foam particles are washed out and no condensate water can be formed in the interstices. However, any heat transfer media such as oil or steam can be used for heating the mold. The hot air or the mold is for this purpose advantageously heated to a temperature in the range from 20to 120° C., preferably from 30 to 90° C.

As an alternative or in addition, sintering can be carried out with injection of microwave energy. In general, microwaves having a frequency in the range from 0.85 to 100 GHz, preferably from 0.9 to 10 GHz, and irradiation times of from 0.1 to 15 minutes are used here.

When hot air having a temperature in the range from 80 to 150° C. is used or microwave energy is injected, a gauge pressure of from 0.1 to 1.5 bar is usually established, so that the process can also be carried out without external pressure and without decreasing the volume of the mold. The internal pressure generated by the microwaves or elevated temperatures allows the foam particles to undergo slight further expansion, with these also being able to fuse together as a result of softening of the foam particles themselves in addition to adhesive bonding via the polymer coating. The interstices between the foam particles disappear as a result. To accelerate setting, the mold can in this case, too, be additionally heated by means of a heat transfer medium as described above.

Double belt plants as are used for the production of polyurethane foams are also suitable for the continuous production of the foam moldings of the invention. For example, the prefoamed and coated foam particles can be applied continuously to the lower of two metal belts, which may, if appropriate, have perforations, and be processed with or without compression by the metal belts moving together to produce continuous foam boards. In one embodiment of the process, the volume between the two belts is gradually decreased, as a result of which the product between the belts is compressed and the interstices between the foam particles disappear. After a curing zone, a continuous board is obtained. In another embodiment, the volume between the belts can be kept constant and the foam can pass through a zone heated by hot air or microwave irradiation in which the foam particles undergo after-foaming. Here too, the interstices disappear and a continuous board is obtained. It is also possible to combine the two continuous process embodiments.

The thickness, length and width of the foam boards can vary within wide limits and is limited by the size and closure force of the tool. The thickness of the foam boards is usually from 1 to 500 mm, preferably from 10 to 300 mm.

The density of the foam moldings in accordance with DIN 53420 is generally from 10 to 120 kg/m³, preferably from 20 to 70 kg/m³. The process of the invention makes it possible to obtain foam moldings having a uniform density over the entire cross section. The density of the surface layers corresponds approximately to the density of the inner regions of the foam molding.

The process of the invention is suitable for producing simple or complex foam moldings such as boards, blocks, tubes, rods, profiles, etc. Preference is given to boards or blocks which can subsequently be sawn or cut to produce boards. They can be used, for example, in building and construction for the insulation of exterior walls. They are particularly preferably used as core layer for the production of sandwich elements, for example structural insulation panels (SIPs) which are used for the construction of cold stores or warehouses.

Further possible applications are foam pallets as a replacement for wooden pallets, facing panels of ceilings, insulated containers, caravans. With a content of flame retardant, these are also suitable for airfreight.

### EXAMPLES

### Starting Materials

Persistol HP=hydrophobicizing agent from BASF, aqueous emulsion comprising 22.8% of paraffin (m.p. 52-54° C.) and 9.6% of resin derived from N-methylolmelamine and stearylamide (m.p. 70° C.)
Ramasit KGT=hydrophobicizing agent from BASF, aqueous emulsion comprising 16.6% of paraffin (m.p. 52-54° C.)

### Preparation of the Coating Mixture B1:

40 parts of water glass powder (Portil N) are added a little at a time with stirring to 60 parts of a water glass solution (Woellner sodium silicate 38140, solids content: 36%, density: 1.37, molar ratio of SiO₂:Na₂O=3.4) and the mixture was homogenized for about 3-5 minutes. 20 parts of an acrylate dispersion (Acronal S790, solids content: about 50%) and 10 parts of Persitol HP were subsequently stirred in.

### Preparation of the Coating Mixture B2:

40 parts of water glass powder (Portil N) are added a little at a time with stirring to 60 parts of a water glass solution (Woellner sodium silicate 38/40, solids content: 36%, density: 1.37, molar ratio of SiO₂:Na₂O=3.4) and the mixture was homogenized for about 3-5 minutes. 20 parts of an acrylate dispersion (Acronal S790, solids content: about 50%) were subsequently stirred in.

### Preparation of the Coating Mixture B3:

40 parts of water glass powder (Portil N) are added a little at a time with stirring to 60 parts of a water glass solution (Woellner sodium silicate 38/40, solids content: 36%, density: 1.37, molar ratio of SiO₂:Na₂O=3.4) and the mixture was homogenized for about 3-5 minutes. 20 parts of an acrylate dispersion (Acronal S790, solids content: about 50%) and 10 parts of Ramasit KGT were subsequently stirred in.

### Preparation of the Coating Mixture B4:

40 parts of water glass powder (Portil N) were added a little at a time with stirring to 60 parts of a water glass solution (Woellner sodium silicate 38/40, solids content: 36%, density: 1.37, molar ratio of SiO₂:Na₂O=3.4) and the mixture was homogenized for about 3-5 minutes. 20 parts of an acrylate dispersion (Acronal S790, solids content: about 50%) were subsequently stirred in.

Polystyrene Foam Particles I (Density: 12 g/l)

Expandable polystyrene (Styropor® F 315 from BASF Aktiengesellschaft) was prefoamed to a density of about 12 g/l on a continuous prefoamer.

Polystyrene Foam Particles II (Density: 15 g/l)

Hydrophobically modified, expandable polystyrene (Peripor® from BASF Aktiengesellschaft) was prefoamed to a density of about 15 g/l on a continuous prefoamer.

### Examples 1 to 3 and Comparative Experiment C1

The polystyrene foam particles I and II were coated with the coating mixture B1, B2, B3 or B4 as shown in Table 1 in a weight ratio of 1:2 in a mixer. The coated polystyrene foam particles were introduced into a Teflon-coated mold which had been heated to 70° C. and pressed by means of a punch to 50% of the original volume. After curing at 70° C. for 30 minutes, the foam molding was removed from the mold. The molding was conditioned further by storing it at ambient temperature for a number of days. The densities of the stored moldings are reported in Table 1.

In an immersion experiment, the water uptake of the foam moldings from Examples 1 to 3 and the comparative experiment was in each case examined. For this purpose, 40×40×40 mm cubes of the respective materials were immersed in a water bath. After defined times, the cube was taken out, the water was allowed to drip off and the weight of the cube was determined. All materials according to the invention from Examples 1 to 3 have a low water uptake (percentage change in the weight in the immersion experiment) compared to the product from the comparative experiment:

| | Ex. 1 | Ex. 2 | Ex. 3 | C1 |
|---|---|---|---|---|
| Foam particles | I | II | II | I |
| Coating | B1 | B2 | B3 | B4 |
| Density of the | 55 | 70 | 72 | 55 |
| molding [g/l] | | | | |
| Water uptake | | | | |
| 0 | 6 | 8 | 8 | 6 |
| 3 hours | 8 | 10 | 9 | 10 |
| 24 hours | 11 | 12 | 11 | 13 |
| Change [%] | 83 | 50 | 38 | 117 |

The foam moldings of Examples 1 to 3 do not drip in the burning test and do not soften backward under the action of heat. They are self-extinguishing and meet the requirements of burning test B2 or E.

Sandwich elements having metal covering layers were produced from the foam boards of Examples 1 to 3: boards having the dimensions 600×100×100 mm and a density as reported in the examples were provided on each side with a 50 μm thick layer of a polyurethane adhesive. Steel plates having a thickness of 1 mm in each case were applied to the adhesive. The adhesive was allowed to cure at 25° C. for 5 hours.

To test the burning behavior in the sandwich element, the element was fastened horizontally (metal surfaces above and below) and a gas burner was placed under the board. The gas flame of this was directed at the middle of the underside of the board, the flame had a height of about 5 cm and a flame temperature of about 600° C. The distance between the tip of the flame and the underside of the board was 2 cm.

Testing of the burning behavior indicated that after the flame had burned for 30 minutes, only a small part of the polystyrene foam between the metal plates had melted. The mechanical stability of the board was retained. The polystyrene foam did not drip and did not ignite. Smoke evolution was very slight.

1. A process for producing foam moldings comprising sintering prefoamed foam particles which have a polymer coating having a glass transition temperature in the range from −60 to +60° C., in a mold under pressure, wherein the polymer coating comprises an amphiphilic or hydrophobic organic compound.

2. The process according to claim 1, wherein the polymer coating comprises a C₁₀-C₃₀ paraffin wax, a reaction product of N-methylolamine and a fatty acid derivative or a polyfluoroalkyl (meth)acrylate or mixtures thereof.

3. The process according to claim 1, wherein the prefoamed foam particles are sintered in the absence of steam.

4. The process according to claim 1, wherein expanded polyolefin or prefoamed particles of expandable styrene polymers are used as foam particles.

5. The process according to claim 1, wherein comminuted particles from recycled foam moldings are used as foam particles.

6. The process according to claim 1 comprising
a) prefoaming of expandable styrene polymers to form foam particles,
b) coating of the foam particles with a polymer solution or aqueous polymer dispersion,
c) introduction of the coated foam particles into a mold and sintering under pressure in the absence of steam.

7. The process according to claim 6, wherein an acrylate dispersion and an aqueous emulsion of a C₁₀-C₃₀ paraffin wax, a reaction product of N-methylolamine and a fatty acid derivative or a polyfluoroalkyl (meth)acrylate or mixtures thereof are used as coating composition in step b).

8. The process according to claim 6, wherein the expandable styrene polymer used in step a) has a coating comprising an amphiphilic or hydrophobic organic compound.

9. The process according to claim 1, wherein the polymer coating comprises alkali metal silicates, metal hydroxides, metal salt hydrates or metal oxide hydrates.

10. The process according to claim 9, wherein the polymer coating is obtained by mixing
from 40 to 80 parts by weight of a water glass solution having a water content of from 40 to 90% by weight,
from 20 to 60 parts by weight of a water glass powder having a water content of from 0 to 30% by weight and
from 5 to 40 parts by weight of a polymer dispersion having a solids content of from 10 to 60% by weight,
or by mixing
from 20 to 95 parts by weight of an aluminum hydroxide suspension having an aluminum hydroxide content of from 10 to 90% by weight,
from 5 to 40 parts by weight of a polymer dispersion having a solids content of from 10 to 60% by weight.

11. (canceled)

12. The process according to claim 2, wherein the prefoamed foam particles are sintered in the absence of steam.

13. The process according to claim 2, wherein expanded polyolefin or prefoamed particles of expandable styrene polymers are used as foam particles.

14. The process according to claim 3, wherein expanded polyolefin or prefoamed particles of expandable styrene polymers are used as foam particles.

15. The process according to claim 2, wherein comminuted particles from recycled foam moldings are used as foam particles.

16. The process according to claim 3, wherein comminuted particles from recycled foam moldings are used as foam particles.

17. The process according to claim 4, wherein comminuted particles from recycled foam moldings are used as foam particles.

18. The process according to claim 2 comprising
a) prefoaming of expandable styrene polymers to form foam particles,
b) coating of the foam particles with a polymer solution or aqueous polymer dispersion,
c) introduction of the coated foam particles into a mold and sintering under pressure in the absence of steam.

19. The process according to claim 3 comprising
a) prefoaming of expandable styrene polymers to form foam particles,
b) coating of the foam particles with a polymer solution or aqueous polymer dispersion,
c) introduction of the coated foam particles into a mold and sintering under pressure in the absence of steam.

20. The process according to claim 4 comprising
a) prefoaming of expandable styrene polymers to form foam particles,
b) coating of the foam particles with a polymer solution or aqueous polymer dispersion,
c) introduction of the coated foam particles into a mold and sintering under pressure in the absence of steam.

21. The process according to claim 5 comprising
a) prefoaming of expandable styrene polymers to form foam particles,
b) coating of the foam particles with a polymer solution or aqueous polymer dispersion,
c) introduction of the coated foam particles into a mold and sintering under pressure in the absence of steam.
